(19) United States
(12) Patent Application Publication
(10) Pub. No.: US 2006/0049385 A1
(43) Pub. Date: Mar. 9, 2006

(54) Ptc material and method for producing same, and circuit protection part using such ptc material and method for manufacturing same

(76) Inventors: Hideki Tanaka, Osaka (JP); Koichi Morimoto, Fukui (JP)

Correspondence Address: STEPTOE & JOHNSON LLP, 1330 CONNECTICUT AVENUE, N.W., WASHINGTON, DC, 20036, US

(21) Appl. No.: 10/532,796

(22) PCT Filed: Nov. 5, 2003
(86) PCT No.: PCT/JP03/14091

§ 371 Date: Apr. 25, 2005

(30) Foreign Application Priority Data
Nov. 6, 2002 (JP) 2002-322250

(51) Int. Cl. H01B 1/12

(52) U.S. Cl. 252/500

(57) ABSTRACT

Provided is a polymeric PTC material having excellent PTC characteristics and a low room temperature resistivity at the same time. In the polymeric PTC material comprising a polymer and carbon black, the carbon black has a ratio of DBP absorption to C-DBP absorption of greater than 1.0 but not greater than 1.1.

### TECHNICAL FIELD

The present invention relates to a PTC material containing a polymer and carbon black and a method for producing the same, and also relates to a circuit protection component using such a PTC material and a method for manufacturing the same.

### BACKGROUND ART

Some conductive polymers contain an organic polymer as the main ingredient and conductive powder such as carbon black or metal dispersed in the polymer. Some of these conductive polymers are known to have a positive temperature coefficient (hereinafter, “PTC”) characteristics. The PTC characteristics indicate a sudden increase in resistance value with increasing temperature in a specific temperature range (called the switching temperature). A conductive polymer having the PTC characteristics is called a “polymeric PTC material” (hereinafter, a “PTC material”). PTC materials are used for self temperature control heaters, circuit protection components (overheat prevention and overcurrent protection) and the like.

The following is a description about a circuit protection component using a PTC material. An overcurrent flowing to an electric circuit with a circuit protection component causes the PTC material to self-heat so as to thermally expand, thereby rapidly increasing the resistance value. As a result, the current is attenuated to be safe and small. This small current condition is maintained until the user turns the power off. It is preferable that a circuit protection component has as low a resistance value as possible to reduce power consumption under normal conditions, and also has as high a breakdown voltage as possible to interrupt the overcurrent completely under abnormal conditions. Consequently, the preferable characteristics of a PTC material are as low a room temperature resistivity as possible and as high a resistivity at and above the switching temperature as possible.

As the conductive particles for a PTC material, carbon black is widely used. The electric characteristics of the PTC material are affected by properties of carbon black. Indicators of the properties of carbon black include particle diameter, specific surface area, structure, surface pH, volatile matter, etc. The particle diameter is measured by arithmetic mean with an electronic microscope. The specific surface area is measured by nitrogen adsorption in accordance with JIS K6217. The structure is measured by dibutylphthalate (DBP) absorption also in accordance with JIS K6217. Larger DBP absorption indicates a more developed structure of the carbon black. As an example of carbon black used for PTC material, Japanese Patent Unexamined Publication No. S55-78406 discloses carbon black which has a particle diameter D of 20 to 150 nm, and which has a ratio S/D of a specific surface area S (m²/g) to the particle diameter D (S/D) of not greater than 10. Japanese Patent Unexamined Publication No. H5-345860 discloses carbon black which has a mean particle diameter D of 80 to 110 nm, a DBP absorption of 110 to 140 ml/100 g, and a specific surface area of 21 to 23 m²/g. These patent documents say that using these carbon blacks can provide PTC materials having a low room temperature resistivity and excellent PTC characteristics.

However, in a PTC material, PTC characteristics are greatly affected not only by the selection of source materials such as carbon black and a polymer, but also by the degree of dispersion of the carbon black in the polymer. A PTC material with an insufficient degree of dispersion cannot obtain sufficient PTC characteristics.

Furthermore, applying too much shear force to a mixture of carbon black and a polymer to improve the degree of dispersion raises the room temperature resistivity too high. Almost all of the conventional examples just define desirable characteristics of the source materials. In addition, these conventional examples show a total amount of shear energy to be applied to a mixture to be dispersed. However, in reality, the total amount of shear energy needed to obtain the optimum degree of dispersion depends on the source material to be selected.

Therefore, evaluating the degree of dispersion to obtain stable PTC characteristics needs a new standard. To solve the aforementioned conventional problem, the present invention has an object of providing a PTC material having excellent PTC characteristics and a low room temperature resistivity and a method for producing the same, and also providing a circuit protection component using such a PTC material and a method for manufacturing the same.

### SUMMARY OF THE INVENTION

In a polymeric PTC material comprising a polymer and carbon black, the carbon black has a ratio of DBP absorption to C-DBP absorption of greater than 1.0 but not greater than 1.1.

### BRIEF DESCRIPTION OF THE DRAWINGS

FIG. 1A shows an aggregate structure of carbon black according to a first embodiment of the present invention.

FIG. 1B shows an agglomerate structure of carbon black according to the first embodiment of the present invention.

FIG. 2 shows a relationship between kneading time, and resistance value and room temperature resistivity at the switching temperature (130° C.).

FIG. 3A shows a perspective view of a laminated circuit protection component according to a second embodiment of the present invention.

FIG. 3B shows a cross section taken along a line A-A shown in FIG. 3A.

FIGS. 4A to 4C show processes in the manufacture of the laminated circuit protection component according to the second embodiment of the present invention.

FIGS. 5A to 5C show processes in the manufacture of the laminated circuit protection component according to the second embodiment of the present invention.

FIGS. 6A and 6B show processes in the manufacture of the laminated circuit protection component according to the second embodiment of the present invention.

FIG. 7 shows a comparison of resistance temperature characteristics between a comparative example and the laminated circuit protection component according to the second embodiment of the present invention.

### DETAILED DESCRIPTION OF PREFERRED EMBODIMENTS

The embodiments of the present invention will be described as follows with reference to accompanying drawings.

Note that the drawings are only schematic and do not show exact dimensions of each component.

### First Exemplary Embodiment

The following is a description about a PTC material and a circuit protection component using the material according to a first embodiment of the present invention.

The PTC material according to the present embodiment comprises a polymer and carbon black. The carbon black used as conductive particles should have a particle diameter of 40 to 130 nm, a specific surface area of 20 to 50 m²/g, and a DBP absorption of 50 to 150 ml/100 g. Using the carbon black in these conditions enables the PTC material to have a low room temperature resistivity and excellent PTC characteristics at the same time.

As the polymer, a thermoplastic resin is used. The thermoplastic resin is selected according to the desired switching temperature. For example, when the switching temperature is not less than 100° C., polyethylene can be used, and more preferably, high-density polyethylene or a copolymer of ethylene-vinyl acetate can be used. Furthermore, in order to prevent thermal oxidation of the polymer, an antioxidant of 0.01 to 1.0 wt % may be added.

The PTC material composition composed of the aforementioned ingredients, that is, a polymer and carbon black can be kneaded by using the following tools. Batch-type tools include two or three heated rolls, Banbury mixers, kneaders, etc. Continuous-type tools include single-screw kneading extruders, twin-screw kneading extruders, etc. It is also possible to finely pulverize a kneaded PTC material to further improve its uniformity.

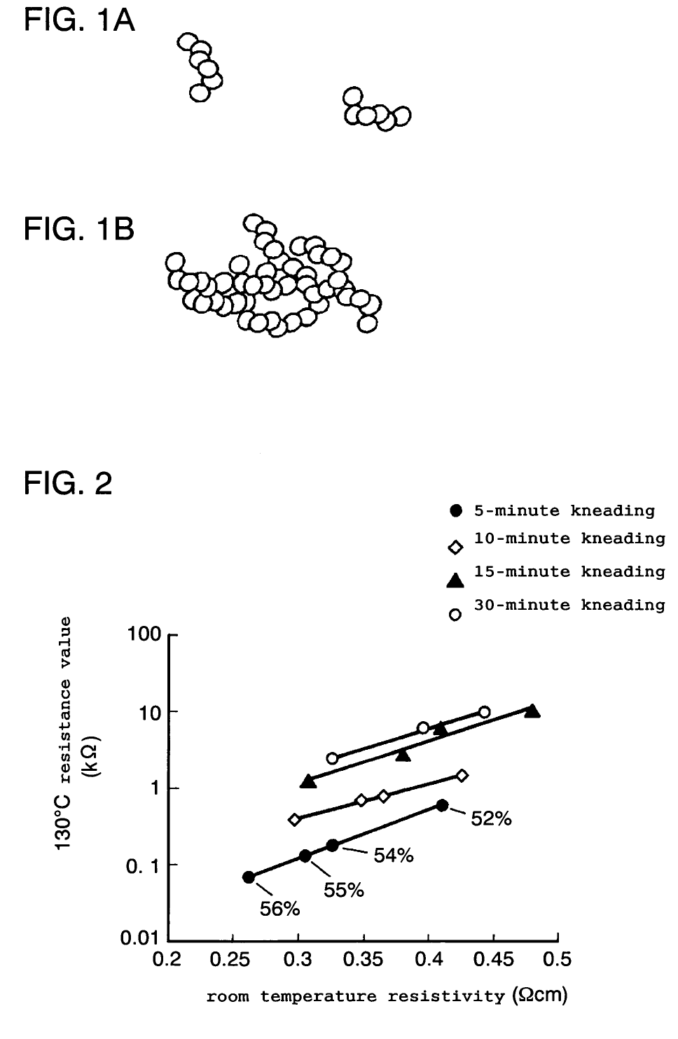

The important thing here is to disperse the carbon black uniformly in the polymer. As shown in FIGS. 1A and 1B, carbon black has two types of structures. FIG. 1A shows an aggregate structure. An aggregate structure is a primary aggregate which is formed of melted primary particles and which is not easily broken. FIG. 1B shows an agglomerate structure. An agglomerate structure is a secondary aggregate, which is an assembly of the aggregate structure. The agglomerate structure makes a transition to aggregate units by being subjected to shear force. In other words, dispersion of carbon black means to make a transition from agglomerate structure to aggregate structure by applying shear force to the carbon black in the polymer. DBP absorption is an index to be applied to both aggregate structure and agglomerate structure. An appropriate index to be applied only to aggregate structure is C-DBP absorption. C-DBP absorption is defined in ASTM D3493 as follows:

“DBP absorption after putting 25 g of carbon black in a cylinder and compressing it four times at a pressure of 165 MPa”. C-DBP absorption thus defined can be used to evaluate the degree of dispersion of carbon black in a polymer.

More specifically, calculating the ratio of DBP absorption to C-DBP absorption (hereinafter the “absorption ratio”) of the carbon black dispersed in the polymer can evaluate the degree of its dispersion.

Here, the ratio of DBP absorption to C-DBP absorption indicates a value obtained by dividing DBP absorption by C-DBP absorption.

For example, when the absorption ratio is determined to be greater than 1.1 but not greater than 2.0, further kneading or pulverization of the PTC material is performed. Making the absorption ratio greater than 1.0 but not greater than 1.1 in this manner indicates that the carbon black is fully dispersed in the polymer. This enables to provide excellent PTC characteristics to carbon black raw materials which are generally used. When the absorption ratio is within the aforementioned range, it is not preferable to further knead or pulverize the PTC material because that would lead to an increase in the room temperature resistivity of the PTC material and also lead to energy waste. The DBP absorption and C-DBP absorption of carbon black in a PTC material is measured as follows. First, the PTC material is heated at 520° C. or higher in an atmosphere of nitrogen so as to decompose the polymer. Then, the carbon black only is taken out of it to measure the absorptions.

The following is a description of a method for manufacturing the circuit protection component.

The PTC material used for the circuit protection component contains the following ingredients. As the carbon black, 52 to 56 wt % of carbon black #3030B (particle diameter: 55 nm, specific surface area: 32 m²/g and DBP: 130 ml/100 g) manufactured by Mitsubishi Chemical Corporation is used. As the high-density polyethylene, 43.9 to 47.9 wt % of HZ5202B (density: 0.964 g/cc, melting point: 135° C. and MFR: 0.33 g/10 min) manufactured by Mitsui Chemicals, Inc. is used. As the antioxidant, 0.1 wt % of TOMINOX TT (registered trademark) manufactured by Yoshitomi Fine Chemical, Ltd. is used.

The aforementioned ingredients are kneaded for 5 to 30 minutes with two heated rolls which have been heated to 170° C., and then the kneaded material is taken out of the rolls in the form of a sheet. Later, the sheet is cut in a specific shape with a mold press, thereby producing a sheet-like PTC layer about 0.16 mm in thickness.

Next, the PTC layer is sandwiched between two electrolytic copper foils (thickness: about 35 μm) having the same length and width as the PTC layer, and is vacuum-hot-pressed for about 1 minute under the conditions of a temperature of 150° C., a degree of vacuum of about 4 kPa and a surface pressure of about 80 kg/cm². This hot pressing allows these components to be bonded integrally with each other. The electrolytic copper foils used in this case form electrodes, so that the copper foil surfaces to be bonded with the PTC layer are roughened by etching.

Using such foil electrodes increases the bonding strength between the PTC layer and the electrodes, thereby making the surface to be bonded harder to fall off.

Next, the sandwich-like laminate thus bonded integrally is subjected to a heat treatment (for 1 hour at 110° C. to 120° C.). The laminate is then put in an electron beam irradiation device where an electron beam of about 40 Mrad is emitted to crosslink the high-density polyethylene. Square pieces of 5 mm×5 mm are taken out of the sandwich-like laminate. Then, leads are attached to the electrodes to complete the circuit protection component.

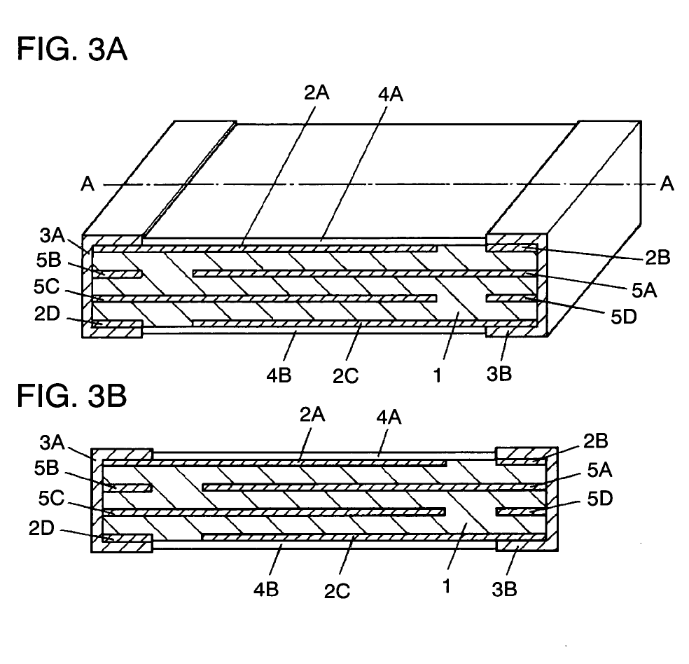

Table 1 shows changes in DBP absorption and C-DBP absorption with kneading time. FIG. 2 shows the relationship between kneading time, and resistance value and room temperature resistivity at the switching temperature (130° C.).

The numeric values (52 wt % to 56 wt %) in FIG. 2 show the content of carbon black.

TABLE 1

| Kneading Time | DBP | C-DBP | Absorption |
|---|---|---|---|
| (min.) | Absorption | Absorption | Ratio |
| 0 | 132 | 86 | 1.53 |
| 5 | 105 | 87 | 1.21 |
| 10 | 95 | 85 | 1.12 |
| 15 | 89 | 83 | 1.07 |
| 30 | 83 | 82 | 1.01 |

The units of DBP absorption and C-DBP absorption are in ml/100 g.

As apparent from Table 1 and FIG. 2, in the case of products having the same resistivity, the longer the kneading time, the greater the resistance value at the switching temperature (130° C.). This improves the PTC characteristics. However, the PTC characteristics hardly improve when the kneading time is 15 minutes or longer where the absorption ratio is not greater than 1.1.

The following is a description about how the PTC characteristics are affected by the method of kneading. The aforementioned material ingredients in the first embodiment of the present invention are mixed and kneaded in the following methods. The content of carbon black is adjusted so that the resistivity of the products can be about 0.4 Ωcm.

(1) kneading (residence time: about 5 minutes) in a single-screw extruder which has been heated to 190° C.

(2) kneading in a single-screw extruder which has been heated to 190° C., and then freeze-crushing to a mean particle diameter of 150 μm.

(3) kneading for 20 minutes by two heated rolls which have been heated to 170° C.

(4) kneading the kneaded material obtained under the conditions of (1) four more times (residence time for each: about 5 minutes) in a single-screw extruder which has been heated to 150° C.

The kneaded materials obtained by these four different methods of kneading are taken out in the form of sheets by being melted with two heated rolls which have been heated to 170° C. Then, these sheets are cut in a specific shape with a mold press so as to produce sheet-like PTC layers about 0.16 mm in thickness.

Next, circuit protection components are manufactured in the same manner as the aforementioned manufacture method.

Table 2 shows the DBP absorptions, the C-DBP absorptions, and the resistance values at the switching temperature (130° C.) in the four different methods of kneading.

TABLE 2

| Kneading | DBP | C-DBP | Absorption | R130° C. |
|---|---|---|---|---|
| Method | Absorption | Absorption | Ratio | (kΩ) |
| Single-Screw | 107 | 85 | 1.25 | 0.52 |
| Extruder | | | | |
| Single-Screw | | | | |
| Extruder + | 85 | 81 | 1.05 | 6.2 |
| Freeze-Crushing | | | | |
| Two Heated Rolls | 87 | 83 | 1.05 | 6.4 |
| 30 Minutes | | | | |
| Single-Screw | | | | |
| Extruder | | | | |
| A total of 5 | | | | |
| times of | 88 | 83 | 1.06 | 6.2 |
| kneading | | | | |

As apparent from Table 2, similar PTC characteristics are obtained by the different methods of kneading as long as the absorption ratio is not greater than 1.1.

### Second Exemplary Embodiment

The structure of a laminated circuit protection component according to a second embodiment of the present invention will be described as follows with reference to accompanying drawings.

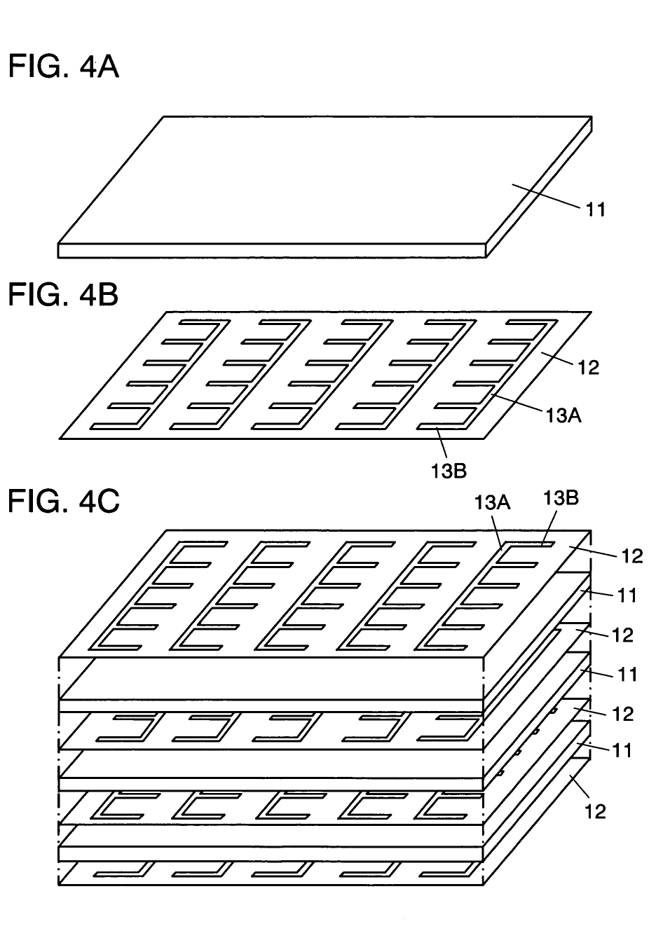

In FIGS. 3A and 3B, PTC layers 1 are made of a PTC material comprising high-density polyethylene and carbon black, and are rectangular parallelepipeds. The carbon black included in PTC layers 1 has an absorption ratio of greater than 1.0 but not greater than 1.1. First main electrode 2A is on the first surface of PTC layers 1. First sub electrode 2B is on the same surface as first main electrode 2A and is independent of it. Second main electrode 2C is on the second surface of PTC layers 1 that is opposed to the first surface. Second sub electrode 2D is on the same surface as second main electrode 2C and is independent of it. All of second sub electrode 2D, first main electrode 2A, first sub electrode 2B and second main electrode 2C are made of electrolytic copper foils or the like.

First side electrode 3A made of a nickel-plated layer is provided in such a manner as to cover the whole surface of one side of PTC layers 1 and further to cover second sub electrode 2D and one end of first main electrode 2A. This establishes an electric connection between first main electrode 2A and second sub electrode 2D. Second side electrode 3B is provided in such a manner as to cover the whole surface of the other side of PTC layers 1 that is opposed to first side electrode 3A, and further to cover first sub electrode 2B and one end of second main electrode 2C. Second side electrode 3B made of a nickel-plated layer electrically connects first sub electrode 2B and second main electrode 2C. First protective layer 4A and second protective layer 4B are made of an epoxy modified acrylic resin, and are respectively provided on the outsides of the first and second surfaces of PTC layers 1. The epoxy modified acrylic resin can be replaced by a mixture of an epoxy resin and an acrylic resin. First inner-layer main electrode 5A is provided inside PTC layers 1 so as to be in parallel with first main electrode 2A and second main electrode 2C. First inner-layer main electrode 5A is electrically connected with second side electrode 3B. First inner-layer sub electrode 5B is on the same surface as first inner-layer main electrode 5A and is independent of it. First inner-layer sub electrode 5B is electrically connected with first side electrode 3A. Second inner-layer main electrode 5C is provided inside PTC layers 1 so as to be in parallel with first main electrode 2A and second main electrode 2C, and is electrically connected with first side electrode 3A.

Second inner-layer sub electrode 5D is on the same surface as second inner-layer main electrode 5C and is independent of it, and is electrically connected with second side electrode 3B.

The laminated circuit protection component according to the second embodiment of the present invention is formed of a plurality of PTC layers 1 made of a PTC material, electrodes 2A to 2D provided on the top surface of the uppermost layer of PTC layers 1 and on the bottom surface of the lowermost layer of PTC layers 1, and electrodes 5A to 5D provided between PTC layers 1. First side electrode 3A and second side electrode 3B are provided so that each of electrodes 2A to 2D and 5A to 5D is not in direct electric connection with an adjacent electrode, but is in direct electric connection with an electrode adjacent to the adjacent electrode. This can increase the breakdown voltage when a circuit abnormality occurs.

In addition, the laminated structure can increase the effective area between the opposed electrodes, with an effect of decreasing the resistance value of the product.

The following is a description of a method for manufacturing the laminated circuit protection component thus structured, with reference to accompanying drawings.

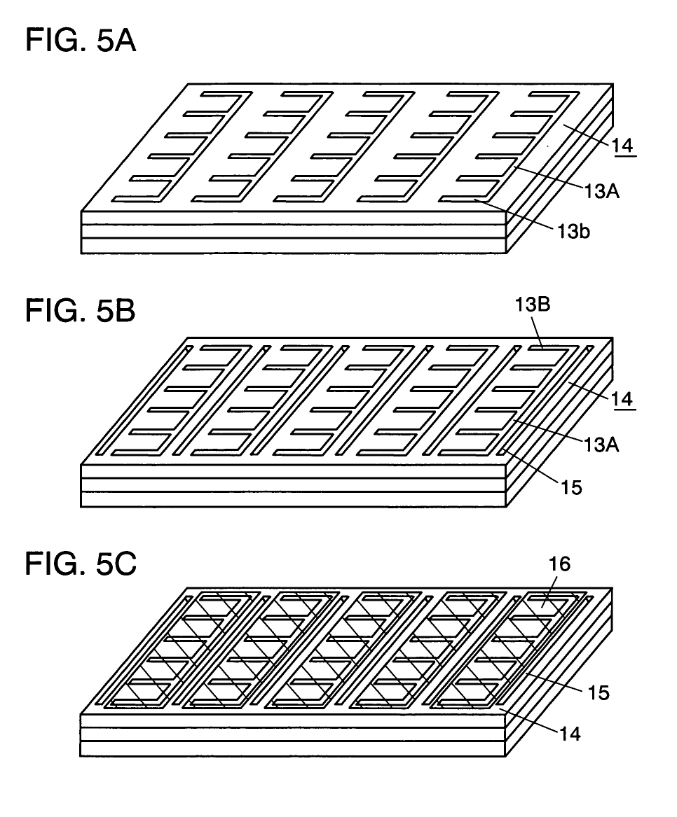

FIGS. 4A to 4C, 5A to 5C and 6A, 6B show the processes in the manufacture of the laminated circuit protection component according to the second embodiment of the present invention.

First, as shown in FIG. 4A, a mixture of 54 wt % of carbon black (#3030B manufactured by Mitsubishi Chemical Corporation), 45.9 wt % of high-density polyethylene (HZ5202B manufactured by Mitsui Chemicals, Inc.) and 0.1 wt % of an antioxidant {TOMINOX TT (registered trademark) manufactured by Yoshitomi Fine Chemical, Ltd.} is kneaded for 20 minutes by using two heated rolls which have been heated to 170° C. Then the kneaded mixture is taken out of the two heated rolls in the form of a sheet. This sheet is cut in a specific shape with a mold press so as to produce sheet-like PTC layer 11 about 0.16 mm in thickness. The carbon black included in PTC layer 11 has an absorption ratio of 1.05.

As shown in FIG. 4B, a plurality of elements are patterned by using a mold press on an electrolytic copper foil having the same length and width as PTC layer 11 shown in FIG. 4A so as to form foil electrode 12. In FIG. 4B, trenches 13A are formed to separate first and second sub electrodes 2B, 2D from first and second main electrodes 2A, 2C, respectively, and to separate first and second inner-layer sub electrodes 5B, 5D from first and second inner-layer main electrodes 5A, 5C when electrode 12 is divided into pieces in a later process. Trenches 13B, on the other hand, are formed to reduce the number of portions to be cut in the electrolytic copper foil, thereby preventing the occurrence of rollover or burrs when the foil is cut into pieces. Trenches 13B are formed also to prevent the electrolytic copper foil, when it is cut, from being exposed on its side. Thus, the electrolytic copper foil can be protected against oxidation or the occurrence of solder short circuits when mounted.

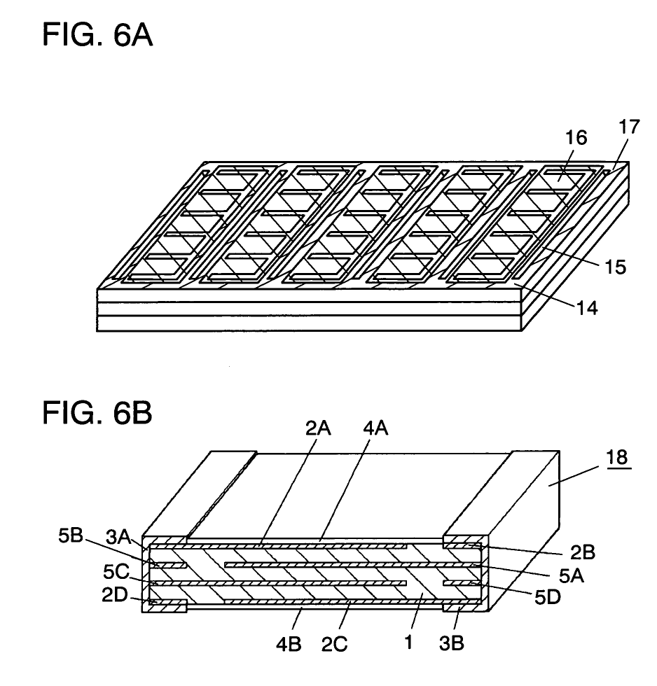

As shown in FIG. 4C, PTC layers 11 are laminated alternately with foil electrodes 12 in such a manner that electrodes 12 are disposed at the outermost positions, and then is vacuum-hot-pressed for about 1 minute under the conditions of a temperature of 150° C., a degree of vacuum of about 4 kPa and a surface pressure of 80 kg/cm². As a result, laminate 14 thus bonded integrally as shown in FIG. 5A is obtained. Later, laminate 14 integrally bonded is subjected to a heat treatment (for 1 hour at 110° C. to 120° C.). The laminate is then put in an electron beam irradiation device where an electron beam of about 40 Mrad is emitted to crosslink the high-density polyethylene.

As shown in FIG. 5B, laminate 14 is provided with long and narrow openings 15 arranged at regular intervals by blanking press or dicing. At that time, a desired width is left uncut in the longitudinal direction of the laminated electronic component.

As shown in FIG. 5C, a resin composition which can be either UV-curable or heat-curable is screen-printed on the top and bottom surfaces of laminate 14 provided with openings 15 except for the vicinity of openings 15. Then, the sides of laminate 14 are preliminary hardened one side at a time in a UV-curing oven, and later, both sides are final-hardened at the same time in a heat hardening furnace so as to form protective layer 16. As the aforementioned resin composition, well-known materials such as epoxy modified acrylic resin can be used.

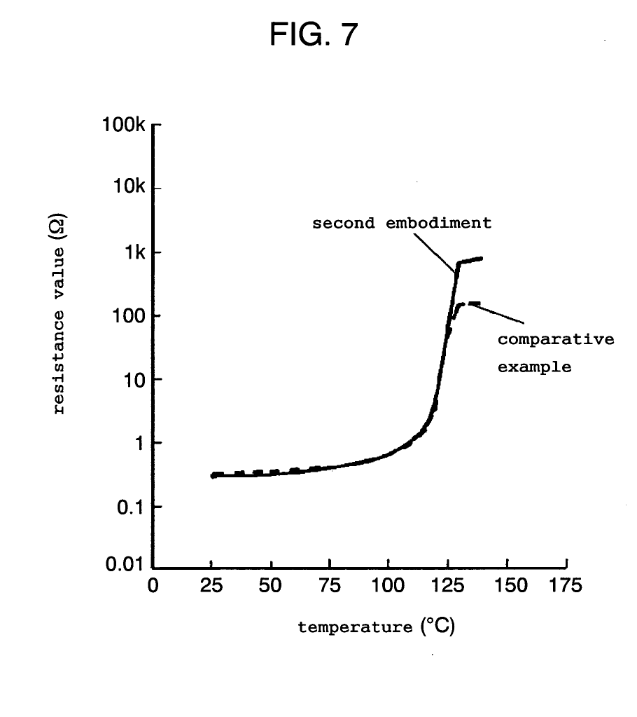

As shown in FIG. 6A, side electrodes 17 are formed on the area of laminate 14 which has no protective layer 16 thereon, and on the inner walls of openings 15.

Side electrodes 17 can be a nickel-plated layer with a thickness of about 30 μm which is formed, e.g. under the conditions of being put in a nickel sulfate bath for about 60 minutes at a current density of about 4 A/dm².

Finally, laminate 14 shown in FIG. 6A is divided into pieces by dicing. This is the completion of laminated circuit protection component 18 according to the second embodiment of the present invention shown in FIG. 6B.

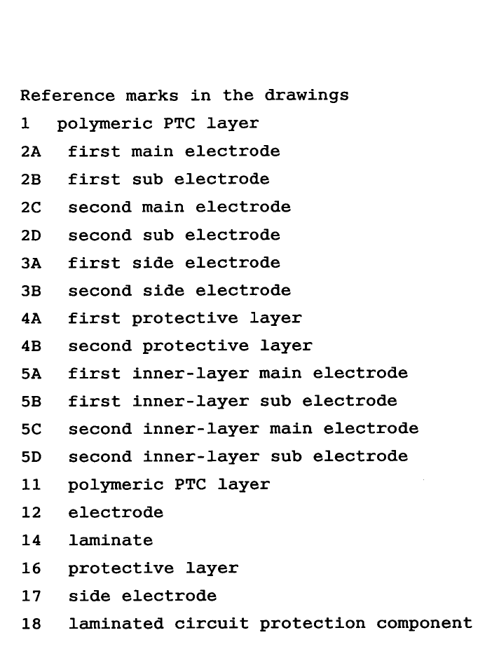

The following is a description about the effects obtained from making the absorption ratio of the carbon black contained in PTC layers 11 according to the second embodiment of the present invention greater than 1.0 but not greater than 1.1. First, as a comparative example, a PTC layer including carbon black whose absorption ratio is 1.21 is used. This PTC layer is used to manufacture a laminated circuit protection component in the same manner as the second embodiment of the present invention. FIG. 7 shows results of comparison in resistance temperature characteristics between the comparative example and laminated circuit protection component 18 of the second embodiment. As apparent from FIG. 7, their room temperature resistance values are nearly the same. On the other hand, at or higher than the switching temperature, laminated circuit protection component 18 of the second embodiment has resistance values greater by about 0.5 orders of magnitude than the laminated circuit protection component of the comparative example.

In the second embodiment, laminate 14 is formed of three PTC layers 11 and four foil electrodes 12; however, the number of lamination is not limited to this, but can be larger or smaller than these numbers. As described hereinbefore, the PTC material of the present invention comprises a polymer and carbon black, and the carbon black has an absorption ratio of greater than 1.0 but not greater than 1.1.

This results in appropriate uniformity of dispersion of the carbon black in the polymer, with an excellent effect of providing excellent PTC characteristics and a low room temperature resistivity at the same time.

### INDUSTRIAL APPLICABILITY

The PTC material of the present invention, which can have excellent PTC characteristics and a low room temperature resistivity at the same time, is useful for self temperature control heaters and circuit protection components.

1. A polymeric PTC material comprising: a polymer and carbon black, wherein
the carbon black has a ratio of DBP absorption to C-DBP absorption of greater than 1.0 but not greater than 1.1.

2. A circuit protection component comprising:
a polymeric PTC layer made of the polymeric PTC material according to claim 1; and
electrodes disposed on a top surface and a bottom surface of the polymeric PTC layer.

3. A circuit protection component comprising:
a plurality of polymeric PTC layers made of the polymeric PTC material according to claim 1; and
a plurality of electrodes disposed on a top surface of an uppermost layer of the plurality of polymeric PTC layers, on a bottom surface of a lowermost layer of the plurality of polymeric PTC layers, and between the plurality of polymeric PTC layers, wherein
each of the plurality of electrodes is not in direct electric connection with an adjacent electrode, but is in direct electric connection with an electrode adjacent to the adjacent electrode.

4. A method for producing a polymeric PTC material comprising a polymer and carbon black, the method comprising the step of:
dispersing the carbon black in the polymer in such a manner that the carbon black has a ratio of DBP absorption to C-DBP absorption of greater than 1.0 but not greater than 1.1.

5. The method for producing the polymeric PTC material according to claim 4, wherein
the step of dispersing the carbon black in the polymer comprises the step of determining whether the ratio of DBP absorption to C-DBP absorption is greater than 1.0 but not greater than 1.1, and continuing to disperse the carbon black when the ratio is outside the range.

6. A method for manufacturing a circuit protection component comprising:
a sheet formation step for processing the polymeric PTC material obtained by the method for producing the polymeric PTC material according to claim 4 into a sheet-like polymeric PTC layer; and
an electrode formation step for forming electrodes on a top surface and a bottom surface of the polymeric PTC layer.

7. A method for manufacturing a circuit protection component comprising:
a sheet formation step for processing the polymeric PTC material obtained by the method for producing the polymeric PTC material according to claim 4 into a sheet-like polymeric PTC layer;
a step for integrally laminating the plurality of polymeric PTC layers alternately with a plurality of electrodes in such a manner that some of the plurality of electrodes are disposed at outermost positions of the plurality of polymeric PTC layers; and
an electrode connection step for establishing an electric connection in such a manner that each of the plurality of electrodes is not in direct electric connection with an adjacent electrode, but is in direct electric connection with an electrode adjacent to the adjacent electrode.
